(19) United States
(12) Patent Application Publication
(10) Pub. No.: US 2018/0080324 A1
(43) Pub. Date: Mar. 22, 2018

(54) FLUIDICALLY CONTROLLED STEAM TURBINE INLET SCROLL

(71) Applicant: General Electric Company, Schenectady, NY (US)

(72) Inventors: AMY LOUISE LYMN, Leicester (GB); DAVID ADEKUNLE ADEOLA, Coventry (GB); GIANLUCA BADJAN, Birmingham (GB); PHILIP JAMES CORSER, London (GB); CRAIG ANDREW LOW, Rugby (GB); ANDREW JAMES WILSON, Northampton (GB)

(21) Appl. No.: 15/270,139

(22) Filed: Sep. 20, 2016

(51) Int. Cl. F01D 1/08; F01D 1/30

(52) U.S. Cl. CPC F01D 1/08; F05D 2220/31; F01D 1/30

(57) ABSTRACT

A turbine inlet includes an annular housing and a main inlet port, a steam outlet, and a flow diversion port in the annular housing. A center axis of flow from the flow diversion port avoids intersecting a center axis of the steam outlet. A turbine system includes a turbine inlet, a fluid supply, and a flow diversion supply conduit. The turbine inlet has an annular housing including a main inlet port therein, a steam outlet therein, and a flow diversion port therein. The flow diversion supply conduit couples the fluid supply to the flow diversion port. A method of retrofitting a turbine inlet in a turbine system comprises opening a flow diversion port through an annular housing of a turbine inlet, connecting a flow diversion supply conduit to the flow diversion port, and connecting the flow diversion supply conduit to the fluid supply.

### BACKGROUND OF THE INVENTION

The subject matter disclosed herein relates to steam turbines. Specifically, the subject matter disclosed herein relates to a turbine inlet and related apparatus or system for providing steam flow into the first stage(s) of a turbine.

Steam turbines include static nozzle assemblies that direct flow of steam, a working fluid, into turbine blades connected to a rotating rotor. The steam is passed through a number of turbine stages, each stage including a row of stationary nozzles mounted to the outer casing and rotating blades mounted to a rotating rotor. The stationary nozzles direct flow of the steam into the blades, rotating the rotor.

In low pressure steam turbines, steam from a high pressure section feeds into the low pressure steam turbine through a low pressure turbine inlet. The turbine inlet includes a housing, a turbine inlet port in the housing, and an annular inlet chamber defined by the housing. The steam flows from a turbine inlet conduit, through the turbine inlet port, through a steam outlet of the inlet chamber, to the first stage nozzles and rotor blades. In many arrangements, the steam does not flow through the annular inlet chamber to the steam outlet evenly or uniformly, meaning the steam does not approach the steam outlet at equal angles at all locations around the steam outlet, or in equal mass flow at all locations around the steam outlet. For example, in many configurations, a disproportionately large portion of the steam flows in a direct stream to the steam outlet and the first stage of nozzles and rotor blades. Toward the periphery of the direct stream, some relatively small percentage of the steam arcs away from the steam outlet and enters the steam outlet at an angle of incidence deviated from a perpendicular to a tangent of the steam outlet where the steam enters the steam outlet. Some relatively small percentage of the steam at the periphery of the direct stream may push farther away from the steam outlet and follow a circumferential path of the annular inlet chamber, before the steam feeds radially inwardly and turns axially through a steam outlet into the first stage.

As a result of this uneven and/or non-uniform flow in the inlet chamber to the steam outlet, the steam does not enter the steam outlet evenly spaced around the circumference of the steam outlet or at uniform angles of incidence to the steam outlet. The steam that does flow circumferentially is turbulent, such that it loses velocity, resulting in energy losses. Also, uneven flow entering the first stage of the low pressure turbine results in a pressure imbalance on the rotor blades, which may stress and fatigue the rotor blades and the rotor, and reduces the life of each. This effect is continued throughout the subsequent stages of the turbine but with a lowering severity until the steam is evenly distributed around the circumference by the blades. Further, the non-uniform angles of incidence of steam at the steam outlet can range plus or minus 40 degrees, which can further cause pressure imbalance, and due to the indirect, non-optimum angles of approaching the components of the first stage, can considerably lower the degree of energy transferred to rotor rotation. Overall cylinder efficiency, because of each of the above reasons, is reduced.

Methods to address these problems include adding vanes inside the annular inlet chamber of the turbine inlet in an attempt to direct the incoming steam circumferentially, to more uniformly and evenly direct the flow of steam to and through the steam outlet. Due to the high-energy conditions inside the turbine inlet, namely the high pressure and velocity of the steam, physical components such as vanes attached inside the turbine inlet, have been found undesirable. Further, the extra components inside the turbine inlet necessitate additional inspections and maintenance, and decrease accessibility inside the turbine inlet. Additional maintenance entails additional shutdowns of the turbine, and less productivity.

Further, in steam turbine retrofits to address problems with uneven and/or non-uniform flow, there are limitations regarding modifications that can be made to the original inner and outer casing geometry, which limit possible solutions to address the uneven and/or non-uniform flow.

### BRIEF DESCRIPTION OF THE INVENTION

A first aspect of the disclosure includes a turbine inlet. The turbine inlet includes an annular housing, a main inlet port in the annular housing, a steam outlet in the annular housing, and a flow diversion port in the annular housing. The annular housing has an outer surrounding peripheral wall and a pair of axially spaced side walls, the annular housing defining an internal chamber. The main inlet port is in fluid communication with the internal chamber for transmitting steam into the internal chamber. The steam outlet is in fluid communication with the internal chamber for passing steam from the internal chamber into a first stage of the turbine, the steam outlet having a center axis. The flow diversion outlet is located and oriented such that flow from the flow diversion port has a center axis angled to avoid intersecting the center axis of the steam outlet.

A second aspect of the disclosure includes a turbine system. The turbine system includes a turbine inlet, a fluid supply, and a flow diversion supply conduit. The turbine inlet has an annular housing which includes a main inlet port therein, a steam outlet centrally positioned therein, a flow diversion port therein, and an outer surrounding peripheral wall and a pair of axially spaced side walls defining an internal chamber. The main inlet port is in fluid communication with the internal chamber for transmitting steam into the internal chamber, and the steam outlet is in fluid communication with the internal chamber for passing steam from the internal chamber into a first stage of a turbine of the turbine system. The flow diversion supply conduit couples the fluid supply to the flow diversion port. The fluid supply is configured to supply fluid into the internal chamber at a higher pressure than steam entering the internal chamber from the main inlet port.

A third aspect of the disclosure includes a method of retrofitting a turbine inlet in a turbine system. The method comprises opening a flow diversion port through an annular housing of a turbine inlet, connecting a flow diversion supply conduit to the flow diversion port, and connecting the flow diversion supply conduit to the fluid supply. The turbine inlet has the annular housing, a main inlet port in the annular housing, and a steam outlet centrally positioned in the annular housing. The annular housing has an outer surrounding peripheral wall and a pair of axially spaced side walls. The annular housing defines an internal chamber. The main inlet port is in fluid communication with the internal chamber for transmitting steam into the internal chamber. The steam outlet is in fluid communication with the internal chamber for passing steam from the internal chamber into a first stage of the turbine. Opening the flow diversion port includes facing the flow diversion port so flow from the flow diversion port has a center axis angled more than five degrees from the center axis of the steam outlet. The fluid supply is configured to supply fluid into the internal chamber at a higher pressure than steam entering the internal chamber from the main inlet port.

### BRIEF DESCRIPTION OF THE DRAWINGS

These and other features of this invention will be more readily understood from the following detailed description of the various aspects of the invention taken in conjunction with the accompanying drawings that depict various embodiments of the disclosure, in which:

FIG. 1 is a perspective partial cut-away illustration of a steam turbine.

FIG. 2 is a schematic cross-sectional illustration of a turbine inlet according to various embodiments.

FIG. 3 is a cross-sectional side view of the turbine inlet of FIG. 2.

FIG. 4 is a schematic cross-sectional illustration of a turbine inlet showing several possible locations and orientations of flow diversion inlets, according to various embodiments.

FIG. 5 is a cross-sectional side view of a turbine inlet, according to various embodiments.

FIG. 6 is a schematic cross-sectional illustration of a turbine inlet showing one possible location and orientation of a flow diversion inlet, according to various embodiments.

FIG. 7 is a schematic block diagram illustration of a turbine system according to various embodiments.

FIG. 8 is a schematic block diagram illustration of a turbine system according to various embodiments.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within a steam turbine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to a position within the flow of a fluid, such as the working fluid through the turbine engine or, for example, the flow of steam through a turbine stage. The term “downstream” corresponds to the direction of flow of the fluid, and the term “upstream” refers to the direction opposite to the flow. The terms “forward” and “aft”, without any further specificity, refer to directions, with “forward” referring to the front or turbine end of the engine, and “aft” referring to the rearward or generator end of the engine. It is often required to describe parts that are at differing radial positions with regard to a center axis. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbine.

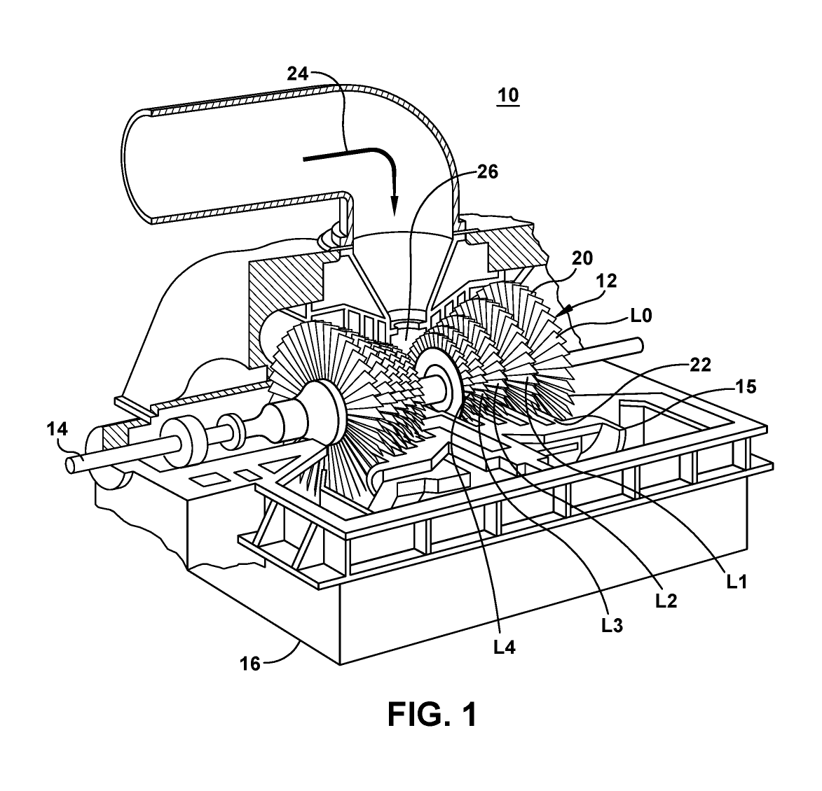

FIG. 1 shows a perspective partial cut-away illustration of a steam turbine 10. Steam turbine 10 includes a rotor 12 that includes a rotating shaft 14. A plurality of rotating blades 20 are mechanically coupled to shaft 14. More specifically, blades 20 are arranged in rows that extend circumferentially around shaft 14 with one row for each stage. A plurality of stationary vanes 22 extend radially from inner casing 15 towards shaft 14. Stationary vanes 22 are axially positioned between adjacent rows of blades 20, cooperating with blades 20 to form each stage and to define a portion of a steam flow path through turbine 10. Rotor 12, blades 20, and stationary vanes 22 are inside an inner turbine casing 15 and an outer turbine casing 16.

In operation, steam 24 enters a turbine inlet 26 of steam turbine 10 and is channeled through stationary vanes 22. Vanes 22 direct steam 24 downstream against blades 20. Steam 24 passes through the remaining stages imparting a force on blades 20 causing shaft 14 to rotate. At least one end of turbine 10 may extend axially away from rotor 12 and may be attached to a load or machinery (not shown) such as, but not limited to, a generator, and/or another turbine.

In one embodiment of the present invention as shown in FIG. 1, turbine 10 comprises five stages. The five stages are referred to as L0, L1, L2, L3, and L4. Stage L4 is the first stage and is the smallest (in a radial direction) of the five stages. Stage L3 is the second stage and is the next stage in an axial direction. Stage L2 is the third stage and is shown in the middle of the five stages. Stage L1 is the fourth and next-to-last stage. Stage L0 is the last stage and is the largest (in a radial direction). It is to be understood that five stages are shown as one example only, and each turbine may have more or less than five stages. Also, as will be described herein, the teachings of the invention do not require a multiple stage turbine.

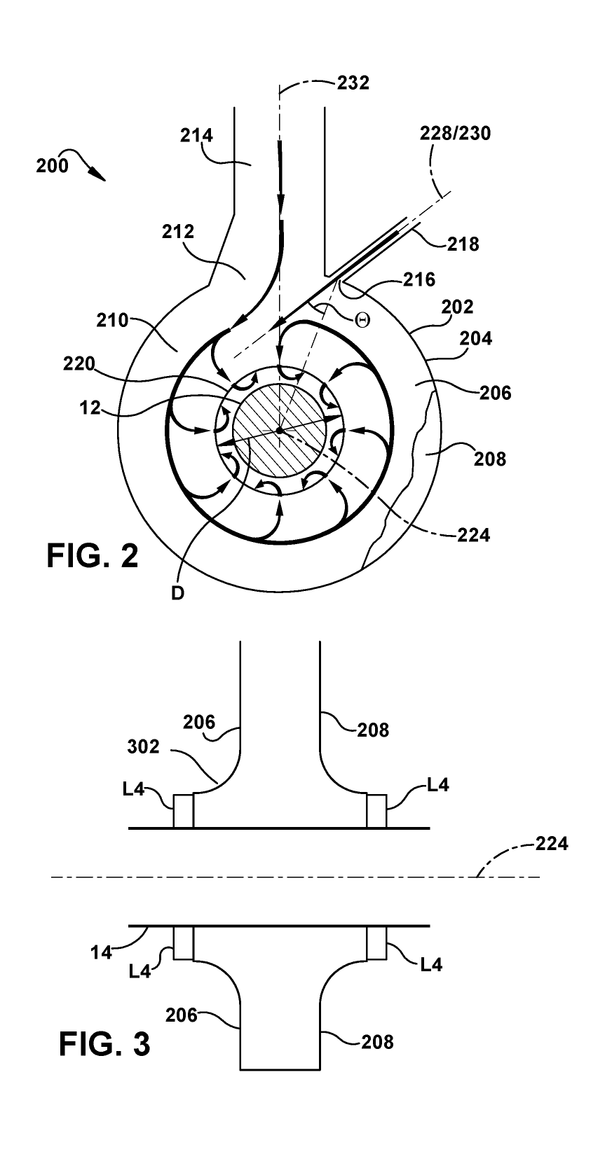

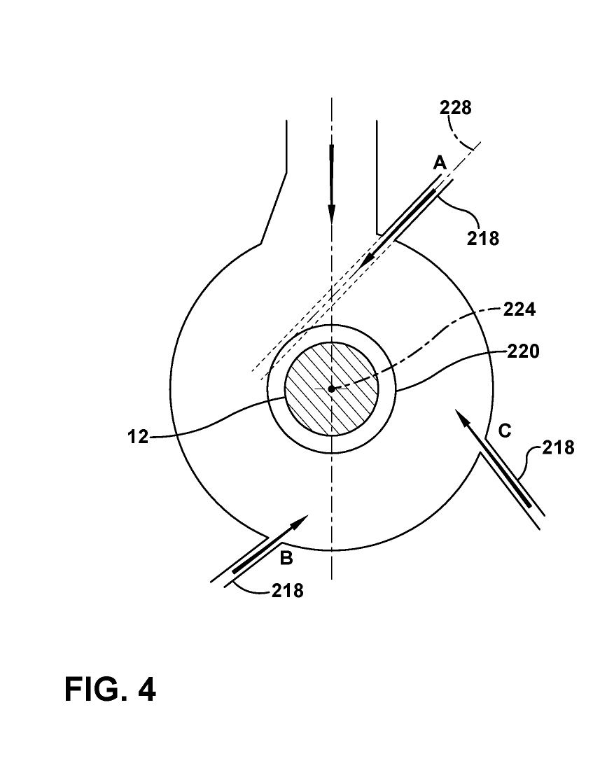

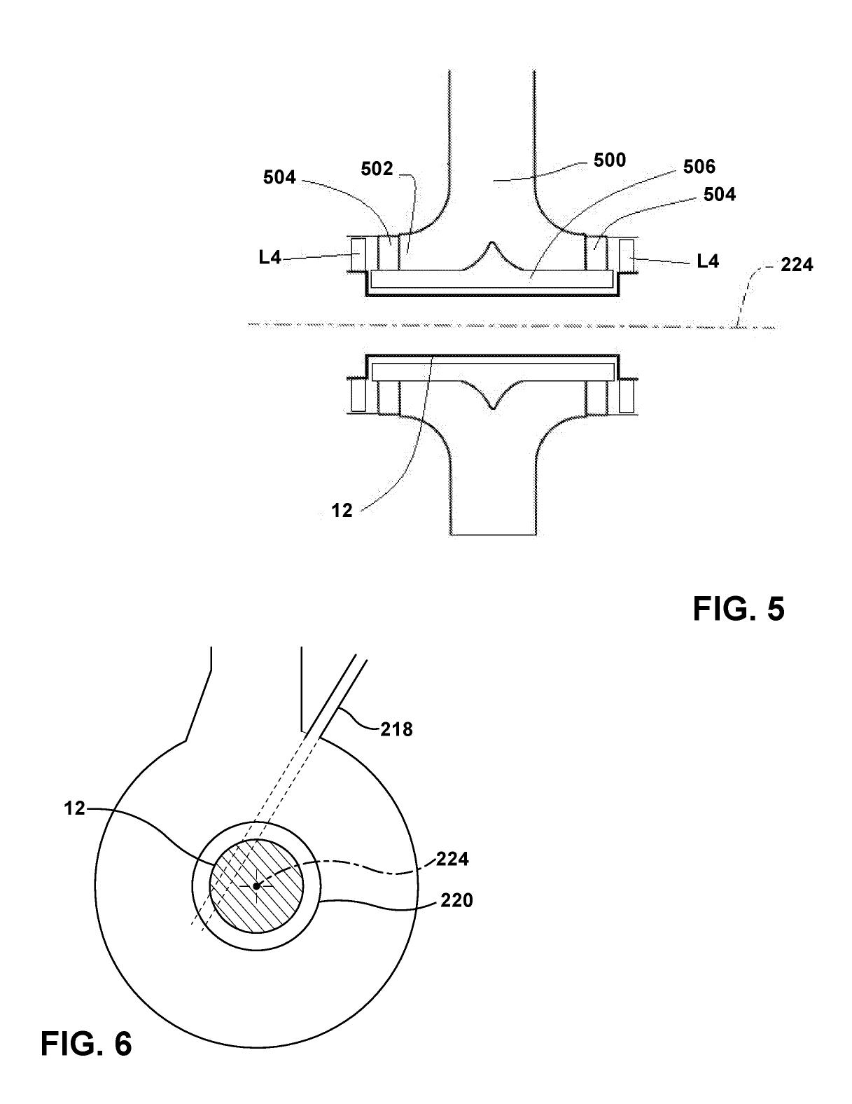

FIG. 2 is a schematic cross-sectional illustration of a turbine inlet 200 with a large portion of a side wall 208 cut away. FIG. 3 is a cross-sectional side view of turbine inlet 200. Turbine inlet 200 includes an annular housing 202 having an outer surrounding peripheral wall 204 and a pair of axially spaced side walls 206, 208. Annular housing 202 defines an internal chamber 210. A main inlet port 212 to turbine inlet 200 includes a first opening through annular housing 202. Main inlet port 212 couples a main steam supply conduit 214 to internal chamber 210. In some embodiments, two opposing main inlet ports 212 can couple two main steam supply conduits 214 to internal chamber 210. A flow diversion port 216 includes a second opening through annular housing 202. Flow diversion port 216 couples a flow diversion supply conduit 218 to internal chamber 210. In some embodiments, more than one flow diversion port 216 couples a respective flow diversion supply conduit 218 to internal chamber 210. FIG. 4 shows some possible locations A, B, and C for multiple flow diversion ports 216. Referring back to FIG. 2 and FIG. 3, a steam outlet 220 from internal chamber 210 to first stage L4 of steam turbine 10 (FIG. 1) includes a third opening through annular housing 202—that is, through one of side walls 206, 208. In a dual flow turbine, the steam outlet 220 also includes a fourth opening through housing 202—that is, through the other of sidewalls 206, 208. Steam outlet 220 can be positioned around a rotor axis such that steam outlet 220 has a center axis 224 coaxial or shared with a center axis of rotor 12, and steam outlet 220 is defined by a gap between rotor 12 and a stationary blade carrier 302. In some instances, as with an impulse turbine, as seen in FIG. 5 showing a turbine inlet 500 with a steam outlet 502, stationary blades 504 have a blade carrier 506 positioned between rotor 12 and an inner diameter of stationary blades 504, such that steam outlet 502 is defined by a gap between portions of stationary blade carrier 506 through stationary blades 502. Center axis 224 of steam outlet 220 can be approximately centrally positioned in side walls 206, 208 in annular housing 202/internal chamber 210 or off-center in annular housing 202/internal chamber 210. A centrally-positioned steam outlet 220 in annular housing 202/internal chamber 210 can facilitate even and uniform flow when a circumferential flow is generated in internal chamber 210.

Main steam supply conduit 214 and main inlet port 212 can be located and oriented anywhere to direct steam into internal chamber 210, such that flow toward and through steam outlet 220 is not even and/or uniform, or such that flow toward and through steam outlet 220 can be redirected or diverted to improve its evenness and uniformity approaching and passing through steam outlet 220. In the example illustrated in FIG. 2, main steam supply conduit 214 and main inlet port 212 are located and oriented to direct steam toward the center of internal chamber 210 or toward steam outlet 220. Such a location and orientation has a center axis 232 of steam flow directed from main steam supply conduit 214 (i.e., center axis 232 of steam flow where steam flow exits main inlet port 212) approximately intersecting a center axis 224 of steam outlet 220. In this location and orientation, main inlet port 212 can face the center of internal chamber 210 or the center of steam outlet 220, i.e., be in general radial alignment therewith.

Main steam supply conduit 214 and main inlet port 212 can also be oriented to face less directly at the center of internal chamber 210 or the center of steam outlet 220, i.e., be more radially misaligned. Main steam supply conduit 214 and main inlet port 212 can face off-center with center of steam outlet 220 such that center axis 232 of steam flow directed from main steam supply conduit 214 is offset from center axis 224 of steam outlet 220 as far as a radius of steam outlet 220, or in some cases a diameter of steam outlet 220. An offset greater than a radius of steam outlet 220 can have steam outlet 220 outside a direct path of a majority of steam flow from main steam supply conduit 214.

Flow diversion port 216 and flow diversion supply conduit 218 can be oriented to direct fluid (e.g., steam, air, etc.) from flow diversion port 216 away from the center of internal chamber 210 or steam outlet 220, and divert steam from main inlet port 212 into a circumferential flow around steam outlet 220, wherein steam more evenly enters steam outlet 220 around the circumference of steam outlet 220, and at more uniform angles of incidence, as schematically depicted in FIG. 2. Flow diversion port 216 and flow diversion supply conduit 218 can be located anywhere around the circumference of annular housing 202, upstream or downstream of main inlet port 212, to push flow circumferentially in internal chamber 210. FIGS. 5 and 6 illustrate some potential locations and orientations around the circumference of annular housing 202 where one or more flow diversion ports 216 can be located. The number, location, and orientation of flow diversion ports 216 can be combined in any desirable manner, and the combinations are not limited to what is illustrated.

Depending on how much adjustment is desired for the main steam flow entering internal chamber 210 at main inlet port 212, a location and orientation can be anywhere in the annular housing 202. In some embodiments, a longitudinal axis 228 of flow diversion supply conduit 218, and/or a center axis 230 of flow exiting flow diversion port 216, avoids intersecting center axis 224 of steam outlet 220. Each flow diversion port 216 illustrated in FIGS. 2, 5, and 6 is configured to release flow with a center axis that avoids intersecting center axis 224 of steam outlet 220. In other words, center axis 230 of flow directed from flow diversion port 216 (i.e., center axis 230 of flow where it exits flow diversion port 216) is angled by an angle θ from center axis of steam outlet 220, wherein the angle can be any value greater than zero, as desired. In some embodiments, the angle can be a value such center axis 230 of flow directed from flow diversion port 216 intersects center axis 232 of main steam flow from main inlet port 212. Depending on the location of flow diversion port 216 around the annular housing 202, the intersection can happen between main inlet port 212 and steam outlet 220, or it can happen on a far side of steam outlet 220 relative to main inlet port 212. For example, referring to FIG. 4 at location A, an intersection of center axis of flow from flow diversion port 216 and center axis 232 of main steam flow from main inlet port 212 between main inlet port 212 and steam outlet 220 increases the diverting effect of flow from flow diversion port 216 on main steam flow from main inlet port 212. At location B, having center axis 230 of flow from flow diverting port 216 intersect center axis 232 of main steam flow from main inlet port 212 on a far side of steam outlet 220 relative to main inlet port 212 can facilitate influencing circumferential steam flow in a radial direction toward steam outlet 220.

In some embodiments, flow diversion port 216 can be angled so no line extending within a periphery of flow diversion port 216 parallel to center axis 230 of flow diversion port 216 intersects center axis 224 of steam outlet 220, as illustrated in FIG. 6. In some cases, such as in the example of position A in FIG. 4, flow diversion supply conduit 218 and flow diversion port 216 are located and oriented to face (or direct fluid) farther from the center of internal chamber 210 or the center of steam outlet 220, such that axis 230 of flow directed from flow diversion port 216 is off-center with the center of steam outlet 220 by at least a radius of steam outlet 220.

In some of these cases discussed above, flow from flow diversion port 216 is directed into the main steam flow entering internal chamber 210 from main inlet port 212. Aiming flow diversion inlet 216 more directly into the path of steam entering inlet 200 through main inlet port 212 can have a greater impact in redirecting the flow circumferentially, which can allow reduction of the pressure and mass flow of diversion flow necessary to achieve a desired level of circumferential flow.

Flow diversion port 216 can have a smaller area than main inlet port 212. A smaller area can facilitate higher pressure to create more impact where the fluid enters internal chamber 210 from flow diversion port 216. The fluid entering inlet 200 through flow diversion port 216 can also have less mass flow than steam entering main inlet port 212. In various embodiments, for example, while many other mass flow values can be implemented, steam can enter inlet 200 through main inlet port 212 at about X kg/s while fluid can enter flow diversion inlet 216 at about X/30 kg/s. For example, in one case, steam can enter inlet 200 through main inlet port 212 at about 210 kg/s while fluid can enter flow diversion inlet 216 at about 7 kg/s. Again, this embodiment is merely one example, and a great range of values can be desirable and implemented. In this embodiment, with flow from flow diversion port 216 being directed into the main steam flow entering internal chamber 210 from main inlet port 212, the range of incidence of steam at steam outlet 220 can be reduced from plus or minus 40 degrees to plus or minus 15 degrees, or less.

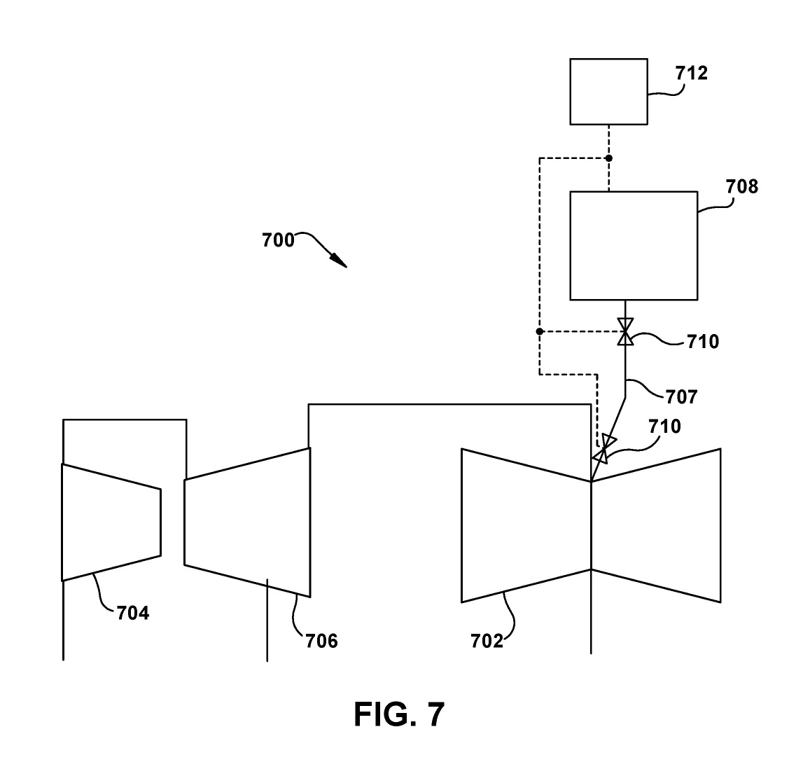

FIG. 7 illustrates a turbine system 700 including a low pressure turbine 702, a high pressure turbine 704, and an intermediate pressure turbine 706, and a flow diversion supply conduit 707. The flow diversion supply conduit 707 is coupled to an external fluid supply 708 to deliver fluid of adequate pressure to the turbine inlet of low pressure turbine 702. External fluid supply 708 can have a supply fluid at a higher pressure than steam entering main inlet port 212. External fluid supply 708 need not have any fluid communication with other portions of turbine system 700, and can be controlled independently of the turbine system 700 to increases or decrease the flow diversion fluid delivered to the turbine inlet of low pressure turbine 702, without affecting operation of intermediate pressure turbine 706 or high pressure turbine 704. A controller 712 can be electrically coupled to external fluid supply 708 for automatic or electronic control of operation, and one or more valves 710 can be equipped in line with flow diversion supply conduit 707, again, to regulate the rate at which flow diversion fluid is delivered to the turbine inlet of low pressure turbine 702. Further, the flow diversion fluid can be shut off entirely either at valve 710 or at external fluid supply 708, without shutting off turbine system 700, which combined with the external components, provides for relatively easy and non-invasive maintenance.

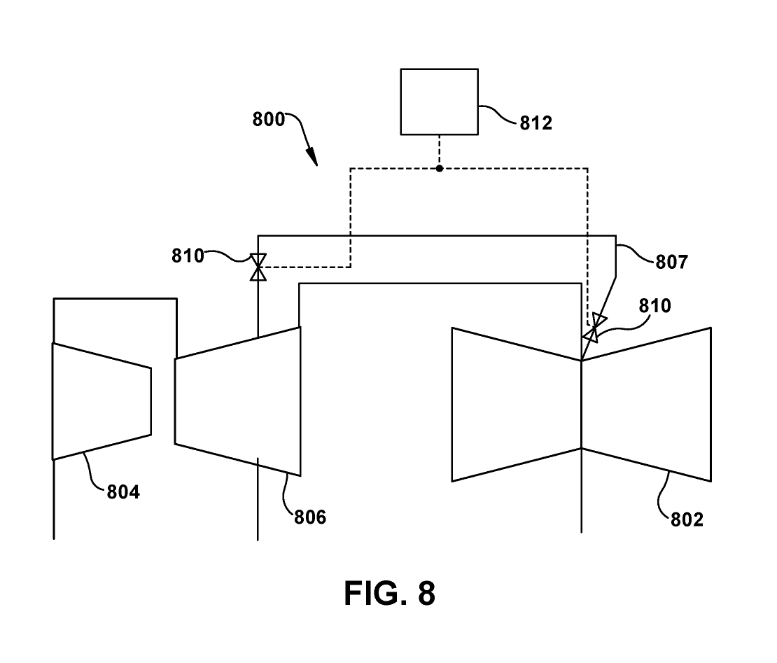

FIG. 8 illustrates a turbine system 800 including a low pressure turbine 802, a high pressure turbine 804, an intermediate pressure turbine 806, and a flow diversion supply conduit 807. Flow diversion supply conduit 807 is coupled to intermediate pressure turbine 806 to supply steam through flow diversion supply conduit 807 to low pressure turbine 802. Flow diversion supply conduit 807 can be tied into an existing intermediate pressure turbine extraction point to reduce equipment and modification, or another point can be selected. A controller 812 can be electrically coupled to turbine system 800 for automatic or electronic control of operation, and one or more valves 810 can be equipped in line with flow diversion supply conduit 807, again, to regulate the rate at which flow diversion fluid is delivered to the turbine inlet of low pressure turbine 802. The flow diversion fluid can also be shut off entirely at valve 810, without shutting off turbine system 800, which combined with the external components, provides for relatively easy and non-invasive maintenance. Coupling to intermediate pressure turbine 806 might reduce its output and efficiency. The energy of the steam extracted from intermediate pressure turbine 806 can be sufficient to achieve the desired circumferential flow with relatively low energy loss, though, and the energy loss can be regained in excess from the improved, circumferential flow in the turbine inlet of low pressure turbine 802. A portion of the energy can also be regained from having a higher enthalpy fluid enter low pressure turbine 802. To facilitate reclaiming enthalpy, blades can be modified, or removed and replaced with differently designed blades. The rate and pressure of flow in flow diversion supply conduit 807 can scale with the power of intermediate pressure turbine 806. For example, when the turbine train, including low pressure turbine 802, high pressure turbine 804, and intermediate pressure turbine 806, runs at half capacity, steam extracted into fluid diversion supply conduit 807 will be reduced in proportion to the overall reduction of steam flow through intermediate pressure turbine 806.

Alternatively, flow diversion supply conduit 807 can be coupled to high pressure turbine 804. As with intermediate pressure turbine 806, the energy extracted from high pressure turbine 804 can be sufficient to achieve the desired circumferential flow, with relatively low energy loss that can be regained in excess from the improved, circumferential flow in the turbine inlet of low pressure turbine 802, and from reclaiming enthalpy (i.e., having a higher enthalpy fluid enter low pressure turbine 802). The shorter distance between intermediate pressure turbine 806 and low pressure turbine 802 than the distance between high pressure turbine 804 and low pressure turbine 802 can demand less equipment, space, and expense.

Also, high pressure turbine 804 extractions could be used to improve the inlet conditions of intermediate pressure turbine 806 inlet. The smaller the gap to reintroduce the extracted steam, the fewer stages that are bypassed and the more energy that is transferred to the rotor upstream of the inlet improved by a flow diversion port. The farther upstream in the turbine train the greater influence the extracted steam will have on the main steam flow into the inlet. The number of stages effected by the bypass increases, though, which may incur a performance penalty. There is a balance between extraction location and penalty incurred by the bypass.

Teachings of the disclosure, as illustrated relative to turbine systems 700, 800, can be implemented as a new design or retrofitted to an existing turbine system. For a retrofit, the outer casing 16 of turbine 10 (FIG. 1) can be removed to access an existing turbine system. An existing low pressure turbine with an inlet, such as the one described with reference to FIG. 2, can be fitted with flow diversion port 216 by opening flow diversion port 216 through a housing of a turbine inlet and angling flow diversion port 216 so center axis 230 of flow from flow diversion port 216 avoids intersecting axis 224 of steam outlet 220 (in other words, off-center with steam outlet 220). Flow diversion supply conduit 707, 807 can be connected from the flow diversion fluid supply (e.g., intermediate pressure turbine 806, high pressure turbine 804, or external fluid supply 708) to flow diversion port 216. The flow diversion fluid supply can be opened for the connection, or the connection can be made at an existing connecting point. Blades 20 can be removed, modified, and replaced, or blades 20 can be removed and replaced with differently designed blades. Modifying a turbine inlet and a turbine system as described herein requires no additional parts internal to the turbine inlet, and minimal or no change to the inner and outer casings of the turbines.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., soldering, fastening, ultrasonic welding, bonding). In various embodiments, electronic components described as being “coupled” can be linked via conventional hard-wired and/or wireless means such that these electronic components can communicate data with one another.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine inlet comprising:
an annular housing having an outer surrounding peripheral wall and a pair of axially spaced side walls, the annular housing defining an internal chamber;
a main inlet port to the annular housing, the main inlet port in fluid communication with the internal chamber for transmitting steam into the internal chamber;
a steam outlet from the annular housing and in fluid communication with the internal chamber for passing steam from the internal chamber into a first stage of the turbine, the steam outlet having a center axis; and
a flow diversion port to the annular housing, wherein flow exiting the flow diversion port is directed so a center axis of the flow avoids intersecting the center axis of the steam outlet.

2. The turbine inlet of claim 1, wherein the flow diversion port has an area and the main inlet port has an area, and the area of the flow diversion port is smaller than the area of the main inlet port.

3. The turbine inlet of claim 1, wherein the flow from the flow diversion port is directed into main steam flow entering the internal chamber from the main inlet port.

4. The turbine inlet of claim 1, wherein the flow diversion port faces off-center from the center of the steam outlet by an amount at least as great as a radius of the steam outlet.

5. The turbine inlet of claim 1, further comprising a flow diversion supply conduit, the flow diversion port coupling the flow diversion supply conduit to the internal chamber.

6. The turbine inlet of claim 1, wherein the center axis of flow entering the internal chamber from the flow diversion port intersects a center axis of main steam flow entering the internal chamber from the main inlet port.

7. The turbine inlet of claim 1, wherein the steam outlet is located concentrically around a center axis of a rotor.

8. A turbine system comprising:
a turbine steam inlet having an annular housing, the annular housing including:
a main inlet port therein,
a steam outlet centrally positioned therein,
a flow diversion port therein, and
an outer surrounding peripheral wall and a pair of axially spaced side walls defining an internal chamber;
a fluid supply; and
a flow diversion supply conduit coupling the fluid supply to the flow diversion port,
wherein the main inlet port is in fluid communication with the internal chamber for transmitting steam into the internal chamber, and the steam outlet is in fluid communication with the internal chamber for passing steam from the internal chamber into a first stage of a turbine of the turbine system,
wherein the fluid supply is configured to supply fluid into the internal chamber at a higher pressure than steam entering the internal chamber from the main inlet port.

9. The turbine system of claim 8, wherein the flow diversion port has an area smaller than an area of the main inlet port.

10. The turbine system of claim 8, wherein the steam outlet has a center axis, wherein the flow diversion port has a periphery and a center axis, and wherein the flow diversion port is oriented so no line extending through the periphery parallel to the center axis of the flow diversion port intersects the center axis of the steam outlet.

11. The turbine system of claim 8, wherein flow from the flow diversion port is directed so a center axis of the flow exiting the flow diversion port is angled more than zero degrees from the center axis of the steam outlet.

12. The turbine system of claim 8, wherein a center axis of flow entering the internal chamber from the flow diversion port intersects a center axis of main steam flow entering the internal chamber from the main inlet port.

13. The turbine system inlet of claim 8, wherein the fluid supply comprises at least one selected from the group consisting of an intermediate pressure turbine, a high pressure turbine, and an external fluid supply, the external fluid supply being fluidly connected to the turbine system only through the flow diversion supply conduit.

14. The turbine system inlet of claim 8, further comprising at least one valve between the fluid supply and the flow diversion port.

15. The turbine system of claim 8, further comprising a control system configured to control a rate of steam flow to the flow diversion port.

16. A method of retrofitting a steam inlet of a turbine in a turbine system, the method comprising:
opening a flow diversion port through an annular housing of a turbine inlet;
connecting a flow diversion supply conduit to the flow diversion port; and
connecting the flow diversion supply conduit to a fluid supply,
the turbine inlet having:
the annular housing, the annular housing having an outer surrounding peripheral wall and a pair of axially spaced side walls, the annular housing defining an internal chamber;
a main inlet port in the annular housing, the main inlet port in fluid communication with the internal chamber for transmitting steam into the internal chamber; and
a steam outlet centrally positioned in the annular housing and in fluid communication with the internal chamber for passing steam from the internal chamber into a first stage of the turbine, the steam outlet having a center axis
wherein opening the flow diversion port includes facing the flow diversion port so flow from the flow diversion port has a center axis angled to avoid intersecting the center axis of the steam outlet,
wherein the fluid supply is configured to supply fluid into the internal chamber at a higher pressure than steam entering the internal chamber from the main inlet port.

17. The method of claim 16, wherein the fluid supply comprises at least one selected from the group consisting of an intermediate pressure turbine, a high pressure turbine, and an external fluid supply, the external fluid supply being fluidly connected to the turbine system only through the flow diversion supply conduit, the fluid supply configured to contain steam at a higher pressure than the turbine.

18. The method of claim 17, further comprising tapping into the fluid supply, the fluid supply being a pre-existing part of the turbine system.

19. The method of claim 16, wherein the center axis of the flow entering the internal chamber from the flow diversion port intersects a center axis of main steam flow entering the internal chamber from the main inlet port.

20. The method of claim 16, wherein the intersection of the center axis of the flow from the flow diversion port and the center axis of main steam flow from the main inlet port is between the steam outlet and the main inlet port.
